(19) United States
(12) Patent Application Publication
(10) Pub. No.: US 2013/0264159 A1
(43) Pub. Date: Oct. 10, 2013

(54) PRODUCTION METHOD AND ABSORBER

(71) Applicants: Adrian Steingruber, Schwabmuenchen (DE); Ernst-Rudolf Luebkert, Landsberg (DE)

(72) Inventors: Adrian Steingruber, Schwabmuenchen (DE); Ernst-Rudolf Luebkert, Landsberg (DE)

(73) Assignee: Hilti Aktiengesellschaft, Schaan (LI)

(21) Appl. No.: 13/993,576

(22) PCT Filed: Nov. 9, 2011
(86) PCT No.: PCT/EP2011/069755

§ 371 Date: Jun. 12, 2013

(30) Foreign Application Priority Data
Dec. 13, 2010 (DE) 10 2010 062 878.6

(51) Int. Cl. F16F 7/108

(52) U.S. Cl. CPC F16F 7/108
USPC 188/380; 29/896.93

(57) ABSTRACT

A production method for an absorber (20) in which a baseplate (24) made of plastic and a support plate (25) made of plastic are arranged at a distance parallel to each other is provided. An elastomer for a spring element (21) is injected between the support plate (25) and the baseplate (24), and a metal mass element (22) is joined positively and/or non-positively to a side of the support plate (25) facing away from the spring element (21).

The present invention relates to a production method for an absorber and to an absorber.

### SUMMARY OF THE INVENTION

In a production method according to the invention for an absorber, a baseplate made of plastic and a support plate made of plastic are arranged parallel to each other at a distance. An elastomer is injected between the support plate and the baseplate. A metal mass element can be mechanically joined to the support plate. The absorber can be fastened in a hand-held power tool.

In one embodiment, several baseplates are arranged on a first holder, several support plates are arranged on a second holder, and the elastomer is injected between the baseplates and the support plates, and the injected elastomer is cut in order to segregate the absorbers.

In one embodiment, the elastomer is injected with a foaming agent.

In one embodiment, the elastomer is injected onto chemically unchanged polyamide or polycarbonate surfaces of the support plate and of the baseplate. The surfaces can be cleaned, for example, with water or solvents to remove dirt or grease. A chemical activation, for example, in order to form hydroxyl or sulfide bridges, is not carried out. In particular, the chemical compounds are sulfur-free.

The absorber according to the invention is formed by layers stacked perpendicular to the working axis, consisting of a baseplate made of plastic, a spring element comprising an elastomer, a support plate made of a stiff plastic, a spring element comprising an elastomer, and a mass element fastened onto the support plate. The support plate is made of a stiffer plastic than the elastomer in such a way that, when the mass element moves, only the spring element is deformed and not the support plate.

The spring element is joined to the baseplate and/or to the support plate with a material bond. According to the invention, the mass element is connected indirectly to the spring element via the support plate.

Due to the high inertia of the mass element, it can be excited to make a movement relative to the baseplate. The spring element installed between the housing and the mass element exerts a return force on the mass element and moves it into a resting position. The spring element preferably has a different stiffness in the three spatial directions; in particular, the stiffness of the spring element is its greatest along the structuring direction and the excitation of the mass element is at its most pronounced perpendicular to the spring element. The spring element preferably has the least stiffness along the working axis so that, to the extent possible, the absorber can be coupled to the periodical excitation of the linear drive.

In one embodiment, the center of gravity of the mass element is at a distance from the center of gravity of the spring element that is less than the height of the spring element. A flat design of the mass element promotes a parallel movement of the mass element parallel to that of the spring element. Tilting and rotating movements of the mass element are suppressed. One dimension of the absorber, can be, for instance, its length. The center of gravity of the mass element can be located within the spring element. For this purpose, for example, the mass element can be placed like a cap over the spring element. An undesired rotating tilting movement in which the roof surface is deflected out of the parallel orientation relative to the base surface is avoided. A dimension parallel to the direction can be greater than any dimension perpendicular to the direction.

The mass element is guided along the working axis by the spring element. Due to the movement of the mass element, the spring element is subject to shearing, which moves the roof surface parallel to the base surface. The special feature of the absorber is its very compact structure and small space requirement for the vibrating mass element. Tilting movements of the spring element are preferably suppressed. The spring element can be configured with two opposite, flat, parallel surfaces to which the baseplate or support plate are fastened.

One embodiment provides that the mass element is joined positively or non-positively to the support plate. Several pins can extend from the support plate in the structuring direction, and the mass element can be placed onto the pins with a positive fit.

In one embodiment, the elastomer is selected from the group consisting of closed-cell foamed polyurethanes and the support is selected among a plastic from the groups consisting of polyamides and polycarbides.

### BRIEF DESCRIPTION OF THE DRAWINGS

The description below explains the invention on the basis of embodiments and figures provided by way of an example. The figures show the following:

FIG. 1: a hand-held power tool,

FIG. 2: an absorber in a side view,

FIG. 3: the absorber of FIG. 2 in a deflected position,

FIG. 4: the absorber of FIG. 2 in an exploded view,

FIG. 5: another absorber,

FIGS. 6 and 7: holders.

### DETAILED DESCRIPTION

Unless otherwise indicated, identical or functionally equivalent elements are designated in the figures by the same reference numerals.

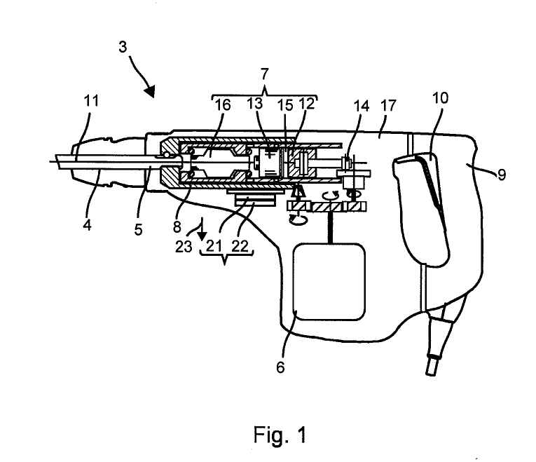

FIG. 1 schematically shows a hammer drill 3. The hammer drill 3 has a bit socket 4 in which a drill chisel 5 can be inserted as the bit. A primary drive of the hammer drill 3 consists of a motor 6 that drives a striking mechanism 7 and a drive shaft 8. A user can guide the hammer drill 3 by means of a handle 9 and can put the hammer drill 3 into operation by means of a system switch 10. During operation, the hammer drill 3 continuously rotates the drill chisel 5 around a working axis 11 and, in this process, can strike the drill chisel 5 along the working axis 11 into a substrate.

The striking mechanism 7 is, for example, a pneumatic striking mechanism 7. An exciter 12 and a striker 13 are movably guided in the striking mechanism 7 along the working axis 11. The exciter 12 is coupled to the motor 6 by means of an eccentric cam 14 or a toggle element, and it is forced to make a periodical, linear movement. An air cushion created by a pneumatic chamber 15 between the exciter 12 and the striker 13 couples a movement of the striker 13 to the movement of the exciter 12. The striker 13 can strike a rear end of the drill chisel 5 directly or else indirectly by transmitting some of its pulses to the drill chisel 5 via an essentially stationary intermediate striker 16. The striking mechanism 7 and preferably the additional drive components are arranged inside a machine housing 17.

The drill chisel 5 that is moved along the working axis 11 as well as the striking mechanism 7 cause recoils that the user absorbs with the handle 9. The peak load is damped by an absorber 20. The absorber 20 has a spring element 21 and a mass element 22 that is fastened onto the spring element 21. The mass element 22 is arranged so that it can be moved along the working axis 11 out of a resting position. In the resting position, the spring element 21 exerts no forces onto the mass element 22 along the working axis 11. Due to its inertia, the mass element 22 is deflected by the vibrations of the machine housing 17 along the working axis 11. The spring element 21 is subject to shearing during the deflection and then exerts a return force along the working axis 11 in the direction of the resting position. The spring constant of the spring element 21 along the working axis 11 and the mass of the mass element 22 are coordinated with the periodicity of the recoils of the striking mechanism 7 in such a way that the recoils excite the absorber 20 preferably resonantly.

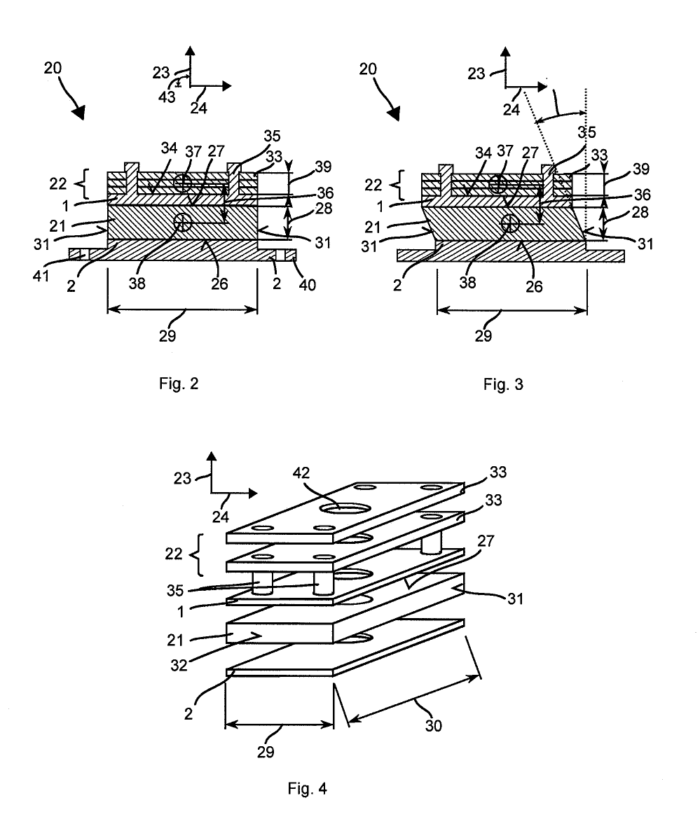

FIGS. 2, 3 and 4 show a more detailed view of the structure of the absorber 20 by way of an example. FIG. 2 shows the mass element 22 in its resting position, FIG. 3 in a deflected position, and FIG. 4 in an exploded view of the absorber 20.

The absorber 20 is essentially structured as a sequence of several layers that are stacked on top of each other in the structuring direction 23. A baseplate 2 serves to fasten the absorber 20 in the hammer drill 3. The spring element 21 is fastened onto the baseplate 2, a support plate 1 is fastened onto the spring element 21, and the mass element 22 is fastened onto the support plate 1.

The structure of the absorber 20 is designed to guide the mass element 22 essentially parallel to the baseplate 2 along an absorption axis 24 and perpendicular to the structuring direction 23. When the mass element 22 is deflected along the absorption axis 24, the spring element 21 is subject to shearing around a shearing angle 25. A tilting movement of the mass element 22 vis-à-vis the structuring direction 23 is largely prevented by the shape of the absorber 20.

The spring element 21 is a preferably contiguous block made of an elastomer. The elastically deformable plastic is a thermoplastic, and closed-cell foams made of polyurethane are particularly suitable. One alternative is silicon rubber.

The spring element 21, shown by way of example as a rectangular parallelepiped, has a flat base surface 26 that, along the structuring direction 23, is at a distance from an opposite parallel flat roof surface 27. The height 28 of the spring element 21, that is to say, its dimension along the structuring direction 23, is less than the length 29, that is to say, its dimension along the working axis 11. A ratio of the height 28 to the length 29 is, for example, in the range between 0.1 and 0.4. The width 30 of the spring element 21, that is to say, its dimension perpendicular to the working axis 11 and perpendicular to the structuring direction 23, is greater than the height 28 and preferably likewise greater than the length 29, for example, by at least 50% greater than the length 29. Side surfaces 31 of the spring element 21 that are oriented parallel or partially parallel to the structuring direction 23 have a much smaller surface area than the perpendicularly oriented base surface 26 and the roof surface 27. The flat structure promotes a shearing movement and exerts strong counterforces against a toggling of the mass element 22.

Instead of the rectangular parallelepiped shape of the spring element 21, the opposite base surface 26 and the roof surface 27 can have a different shape, for example, hexagonal, circular, in other words, the block can have a different prismatic shape. Moreover, the side surfaces 31 can be slanted perpendicularly to the absorption axis 24 and, in particular, the parallel side surfaces 32 can be slanted parallel to the absorption axis 24 relative to the structuring direction 23. The base surface 26 and the roof surface 27 which are arranged perpendicular to the structuring direction 23 are preferably flat.

The support plate 1 is made of a stiff plastic, for example, of polyamide or polycarbonate. Special preference is given to a combination of polyamide for the support plate 1 and a closed-cell foam made of polyurethane for the spring element 21. The spring element 21 and the support plate 1 can be joined together with a material bond by means of an injection-molding process, as a result of which the plastic of the spring element 21 bonds chemically to the plastic of the support plate 1. The support plate 1 can be cleaned before the spring element 21 is injection-molded onto it. Further preparatory treatment steps such as, for example, applying a primer onto the support plate as is done in the case of vulcanization, are not necessary. As an alternative, the support plate 1 can be glued onto the spring element 21.

The baseplate 2 can be made of the same plastic as the support plate 1. In one embodiment, the baseplate 2 has an iron core that is coated with the plastic. The base surface 26 of the spring element 21 is preferably joined to the baseplate 2 with a material bond, for example, by means of glue or by injection-molding the spring element 21 onto the baseplate 1.

The opposite base surface 26 and roof surface 27 of the spring element 21 touch the baseplate 2 and the support plate 1. The smaller side surfaces 31, 32 are completely exposed, especially the side surfaces 31 that are oriented perpendicular to the working axis 11.

The support plate 1 serves to join the mass element 22 to the spring element 21. The circumference of the support plate 1 is preferably congruent with the roof surface 27 of the spring element 21. The forces from the elastic spring element 21 are introduced uniformly into the stiff support plate 1 over the entire roof surface 27. Cross sections of the mass element 22 parallel to the roof surface are the same as the roof surface 27 or else are located within the roof surface 27.

The mass element 22 is made of iron or of another material having a comparable or greater density. The mass of the mass element 22 equals at least twice the mass of the spring element 21. The mass element 22 can be made up of a single block or preferably of several stamped metal sheets 33.

The mass element 22 is preferably fastened onto the support plate 1 by means of a positive or non-positive connection. For example, studs or pins 35 are arranged on the side 34 of the support plate 1 facing away from the spring element 21. The mass element 22 can be latched with the pins 35. In particular, the mass element 22 can be made up of several stamped metal sheets 33 that are pushed onto the pins 35 one at a time. The tip of the pin 35 can be crushed to form a knob.

The mass element 22 is contact-free relative to the spring element 21, that is to say, it is not in direct contact with the spring element 21. The dimensions of the mass element 22 perpendicular to the structuring direction 23, especially the length 29 parallel to the absorption axis 24, are equal to the corresponding dimensions of the spring element 21.

The distance 36 of the center of gravity 37 of the mass element 22 from the center of gravity 38 of the spring element 21 is preferably less than the height 28 of the spring element 21. The height 39 of the mass element 22 can be less than the height 28 of the spring element 21.

The baseplate 2 serves to fasten the absorber 20 into or onto the hand-held power tool 3. Wings 40 of the baseplate 2 projecting laterally beyond the other components of the absorber 20 can be provided, for instance, with drilled holes 41 or threads.

A continuous opening 42 can extend along the structuring direction 23 from the baseplate 2 all the way through the mass element 22. The opening 42 in the baseplate 2 has a smaller diameter than in the spring element 21. A screw head of a screw can be arranged inside the spring element 21 in order to fasten the baseplate 2, and thus the entire absorber 20, to a substrate.

The absorber 20 is preferably arranged in the machine housing 17. The absorber 20 can be fastened, for example, to the machine housing 17 or to the striking mechanism 7. The structuring direction 23 is preferably slanted at an angle 43 that is greater than 80° relative to the working axis 11, preferably perpendicular to the working axis 11. The absorber 20 can also be installed in other hand-held power tools, for example, a compass saw or a saber saw.

Further damping of the recoils can be achieved by a spring suspension of the handle 9 on the machine housing 17. The spring suspension damps the transmission of vibrations from the machine housing 17 to the handle 9.

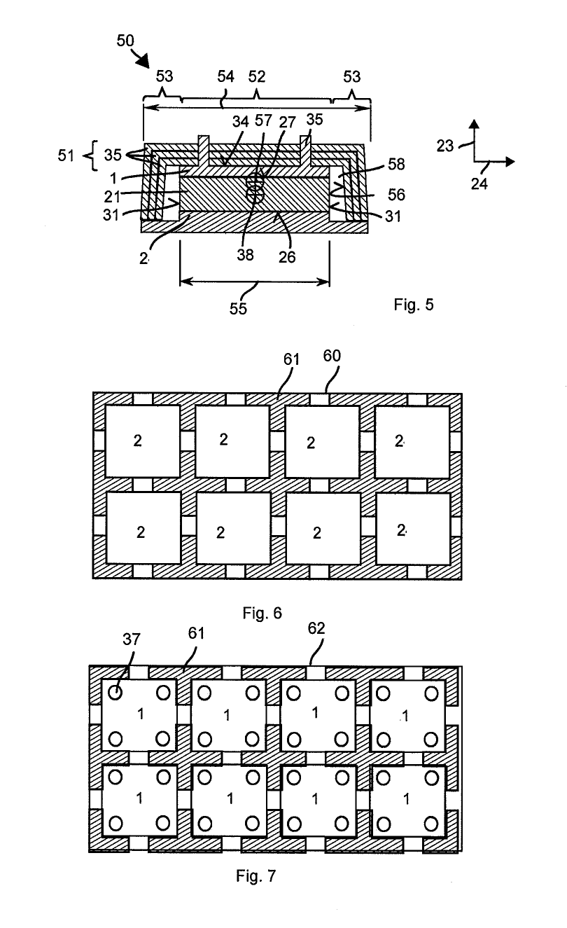

FIG. 5 shows another embodiment of an absorber 50 with a spring element 21 and a mass element 51. Analogously to the absorber 20, the absorber 50 is structured in the form of several elements that are stacked on top of each other in the structuring direction 23. The spring element 21 is fastened onto the baseplate 2, a support plate 1 is fastened onto the spring element 21, and the mass element 51 is fastened onto the support plate 1. The spring element 21, the baseplate 2 and the support plate 1 can be configured in the same was as in the embodiments described above.

The mass element 51 has a middle section 52 that rests on the support plate 1. One edge 53 of the mass element 51 projects laterally beyond the spring element 21, that is to say, in at least one direction perpendicular to the structuring direction 23. In the absorber 50 presented by way of an example, the width 54 of the mass element 51 is greater than the width 55 of the spring element 21. The width refers to a dimension parallel to the absorption axis 24 and perpendicular to the structuring direction 23. The edge 53 is preferably slanted relative to the middle section 52 and in the direction of the spring element 21. The mass element 51 is configured to be dish-shaped with a concave surface 56 facing the spring element 21. Due to the angled edge 53, the center of gravity 57 of the mass element 51 can be located within the spring element 21. In one variant, the center of gravity 38 of the spring element 21 and the center of gravity 57 of the mass element 51 coincide.

The side surfaces 31 of the spring element 21 are at a distance from the edge 53, for example, separated by a cavity 58, which is why it is only via the roof surface 27 of the spring element 21 that the mass element 59 can introduce the forces resulting from its inertia.

A production method for the absorber 20 first calls for the manufacture of the baseplates 2 and the support plates 1. These plates can be made, for example, of polyamide or polycarbonate by means of an injection-molding process. The support plates 1 hold the pins 35 or other latching elements. Several of the baseplates 2 are arranged next to each other on a first holder 60 (FIG. 6). The first holder 60 can have studs 61 that hold the baseplates 2 at defined distances. Several of the support plates 1 are arranged on a second holder 62 (FIG. 7). The two holders 60, 62 are oriented parallel and opposite from each other at a distance that corresponds to the later height 28 of the spring element 21. Each baseplate 2 is situated opposite from a support plate 1.

The spring element 21, as a closed-cell foam made, for instance, of polyurethane, is inserted between the two holders 60, 62. The polyurethane, together with a foaming agent, is injected into the interstice. The foam reacts chemically with the polystyrene or polycarbonate of the plates 2, 1. A pretreatment, for example, chemical activation of the plates by means of a primer, is not provided for. In one variant, a rubber is injected as the material for the spring element 21.

Once the foam has hardened, the block consisting of baseplates, support plates and the solid foam is removed from the holders 60, 62. A saw, for example, a water-jet saw, cuts the foam along the contour of the baseplates 2 or support plates 1 in order to separate the block into several base elements for the absorber 20.

Subsequently, the mass elements 22 are mechanically joined to the support plate 1. The mass element 22 has, for instance, drilled holes with which it is placed onto the pins 35. The mass element 22 can be structured from a stack of several metal sheets 33. Then a stamping tool can crush the pins 35 in order to form rivet heads.

In one variant of the production method, first of all, a first plate of contiguous baseplates 2 is made. The first plate is repeatedly structured with the shape of the baseplates 2. By the same token, a second plate of contiguous support plates 1 can be made in that the shape of the support plates 1 is repeated multiple times on the second plate. The support plates 1 can be connected to each other, for example, by means of thin struts. The first plate and the second plate are arranged opposite form each other. The foam for the spring element 21 is injected between the plates. Subsequently, the block consisting of the two plates and the foam is sawed into individual base elements for the absorbers 20, and then the mass element 22 is attached.

What is claimed is:

1-13. (canceled)

14. A production method for an absorber comprising:
arranging a baseplate made of plastic and a support plate made of plastic parallel to each other at a distance;
injecting an elastomer for a spring element between the support plate and the baseplate; and
joining a metal mass element to a side of the support plate facing away from the spring element.

15. The production method wherein the joining including joining the metal mass element positively to the side.

16. The production method wherein the joining including joining the metal mass element non-positively to the side.

17. The production method as recited in claim 14 wherein several baseplates are arranged on a first holder, several support plates are arranged on a second holder, and the elastomer is injected between the baseplates and the support plates, and the injected elastomer is cut in order to segregate the absorbers.

18. The production method as recited in claim 14 wherein the elastomer is injected with a foaming agent.

19. The production method as recited in claim 14 wherein the elastomer is injected onto chemically unchanged polyamide or polycarbonate surfaces of the support plate and of the baseplate.

20. An absorber formed in a structuring direction by stacked layers of a baseplate made of plastic, a spring element comprising an elastomer, a support plate made of plastic, and a mass element fastened onto the support plate, the spring element being joined by injection-molding to the baseplate and/or to the support plate with a material bond.

21. The absorber as recited in claim 20 wherein the elastomer is selected from the group consisting of closed-cell foamed polyurethanes.

22. The absorber as recited in claim 20 wherein the support is selected among a plastic from the groups consisting of polyamides and polycarbides.

23. The absorber as recited in claim 20 wherein the mass element is joined positively to the support plate.

24. The absorber as recited in claim 20 wherein the mass element is joined positively to the support plate.

25. The absorber as recited in claim 20 wherein a center of gravity of the mass element is at a distance from a center of gravity of the spring element that is less than a height of the spring element.

26. The absorber as recited in claim 20 wherein a center of gravity of the mass element is located within the spring element.

27. The absorber as recited in claim 29 wherein a dimension of the absorber along the structuring direction is less than the dimension of the absorber along the working axis.

28. The absorber as recited in claim 20 wherein the spring element is joined to the baseplate at a base surface, and to the support plate at a roof surface, the base surface being parallel to the roof surface.

29. The absorber as recited in claim 18 wherein several pins extend from the support plate in the structuring direction, and the mass element is placed with a positive fit onto the pins.
